(19) United States
(12) Patent Application Publication
(10) Pub. No.: US 2008/0094972 A1
(43) Pub. Date: Apr. 24, 2008

(54) Method and Device for Focus Management When Recording on Optical Storage Media

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,599

(22) PCT Filed: Jan. 6, 2006
(86) PCT No.: PCT/IB06/50054

§ 371 Date: Jul. 10, 2007

(30) Foreign Application Priority Data
Jan. 13, 2005 (EP) 05100181.6

(51) Int. Cl. G11B 7/09

(52) U.S. Cl. 369/47.53

(57) ABSTRACT

The present invention relates to a method and a parameter-determining unit (100) for determining a first focus offset parameter value. The method of determining this parameter value for writing content data to a multilayer storage medium (114) comprises the steps of writing test data sequences using different estimated first focus offset parameter values (step 206), reading the test data sequences (step 206), determining values of at least one data deviation measure of the read test data sequences (step 206), and determining the first focus offset parameter value in dependence upon the determined values of at least one data deviation measure (steps 210,222), such that the block error rate of the read-out of content data, written to the multilayer storage medium (114) while using the determined first focus offset parameter value and read from the multilayer portable storage medium (114) while using the determined second focus offset parameter value, is minimized.

The present invention relates to optimizing the focusing of a recording beam when recording on recordable double-layer storage media. The present invention is particularly advantageous for focus management when recording on portable optical storage media.

In order to meet recent demands from the gaming industry and others for an improved performance of the data rate, the spinning speed of optical discs, as one example of portable storage media, has been increasing. However, by increasing this spinning speed, error margins associated with, for instance, the optical disc at the increased spinning speed decrease. As a consequence of decreased error margins, steps and measures are developed in order to provide and ensure an improved performance.

U.S. Pat. No. 5,561,645 A discloses a method and apparatus for focusing a recording light beam on a recording medium. The apparatus includes moving means for moving an optical head in a direction perpendicular to the recording medium so as to change the focus position of the recording light beam irradiated by the optical head. The method comprises the steps of detecting reflected light for producing a focus error signal, generating a mark efficiency signal at several trial focus positions, determining the mark efficiency signal corresponding to an in-focus position, determining an offset value of the associated focus error signal, and, during recording, adjusting the position of the movable focusing means so that the value of the focus error signal is maintained at the offset value. The mark efficiency signal is a measure dependent on the relative illumination of a plurality of photo detectors.

The above document discloses changing the focus position of the recording light beam based on determined reflected light during recording. However, the performance in terms of block or bit error rates of data during reading and writing is important for a consumer. It is observed that U.S. patent U.S. Pat. No. 5,561,645 A does not include the step of changing the focus position of the recording light in dependence upon any such data error rate measures.

There is thus a need to provide improved focus management, especially during reading and writing of double-layer storage media.

The present invention relates to determining optimized focusing for recording on recordable multilayer (including double-layer) portable storage media.

This is achieved by using separate focusing for writing data to a storage medium and for reading data from the storage medium, for each one of the data layers of the multilayer storage medium.

It is a first object of the present invention to determine separate focusing for writing data to and reading data from the multilayer storage medium. According to this first aspect of the present invention, this object is achieved by a method of determining a first focus offset parameter value for writing content data to a multilayer storage medium, based on a determined second focus offset parameter value for reading, the method comprising the steps of writing test data sequences using different estimated first focus offset parameter values, reading the test data sequences using the determined second focus offset parameter value, determining values of at least one data deviation measure of the read test data sequences for at least some of the estimated first focus offset parameter values, and determining the first focus offset parameter value in dependence upon the determined values of at least one data deviation measure, such that the block error rate of the read-out of content data, written to the multilayer storage medium while using the determined first focus offset parameter value and read from the multilayer storage medium while using the determined second focus offset parameter value, is minimized.

It is a second object of the present invention to provide a unit for determining separate focusing for writing data to and reading data from the multilayer storage medium. According to this second aspect of the present invention, this object is achieved by a first focus offset parameter value-determining unit for determining a first focus offset parameter value for writing data to a multilayer storage medium based on a determined second focus offset parameter value, said first focus offset parameter value-determining unit comprising a data-writing unit arranged to write test data sequences to the storage medium using different estimated first focus offset parameter values, a data-reading unit arranged to read test data sequences from the storage medium using a second focus offset parameter value, a first data deviation measure-determining unit arranged to determine values of a first data deviation measure of the read test data sequences for at least some of the estimated first focus offset parameter values, a control unit connected to the data-writing unit, the further data-writing unit and the first data deviation measure-determining unit, said control unit being arranged to control writing the test data sequences using different estimated first focus offset parameter values, reading the test data sequences using a second focus offset parameter value, determining values of at least one data deviation measure of the read test data sequences for at least some of the estimated first focus offset parameter values, and determining the first focus offset parameter value in dependence upon the determined values of at least one data deviation measure, such that the block error rate of the read-out of data, written to the multilayer storage medium while using the determined first focus offset parameter value and read from the multilayer storage medium while using the determined second focus offset parameter value, is minimized.

It is a third object of the present invention to provide a device for storing a parameter related to determining separate focusing for writing data to and reading data from the multilayer storage medium on the same multilayer storage medium. According to this third aspect of the present invention, this object is achieved by a storage medium-initializing device for initializing a multilayer storage medium, wherein said storage medium-initializing device is arranged to receive the multilayer storage medium, the device comprising a first focus offset parameter value-determining unit for determining a first focus offset parameter value for writing data on a multilayer storage medium based on a determined second focus offset parameter value, said first focus offset parameter value-determining unit comprising a data-writing unit arranged to write test data sequences to the storage medium using different estimated first focus offset parameter values, a data-reading unit arranged to read test data sequences from the storage medium using a second focus offset parameter value, a first data deviation measure-determining unit arranged to determine values of a first data deviation measure of the read test data sequences for at least some of the estimated first focus offset parameter values, a control unit connected to the data-writing unit, the further data-writing unit and the first data deviation measure-determining unit, said control unit being arranged to control writing the test data sequences using different estimated first focus offset parameter values, reading the test data sequences using a second focus offset parameter value, determining values of at least one data deviation measure of the read test data sequences for at least some of the estimated first focus offset parameter values, and determining the first focus offset parameter value in dependence upon the determined values of at least one data deviation measure, and arranged to determine a first focus offset parameter value, such that the storage medium-initializing device can initialize the multilayer storage medium by storing at least a parameter value that is related to the first focus offset parameter value on said storage medium.

It is a fourth object of the present invention to provide a method of using separate focusing for writing data to and reading data from the multilayer storage medium, for storing content data on the multilayer storage medium. According to this fourth aspect of the present invention, this object is achieved by a method of writing content data to a multilayer storage medium, the method comprising the steps of obtaining a parameter at least related to the first focus offset parameter value as determined by means of the method of determining a first focus offset parameter value for writing content data on a multilayer storage medium based on a determined second focus offset parameter value for reading, writing the test data sequences using different estimated first focus offset parameter values, reading the test data sequences using the determined second focus offset parameter value, determining values of at least one data deviation measure of the read test data sequences for at least some of the estimated first focus offset parameter values, and determining the first focus offset parameter value in dependence upon the determined values of at least one data deviation measure, in dependence upon the multilayer storage medium, and writing content data to a layer of the multilayer storage medium by using the obtained first focus offset parameter value, such that the block error rate of a read-out of the written data is minimized.

In a preferred embodiment of the present invention, using a multilayer storage medium, the method of determining the first focus offset parameter value for writing content data to the multilayer storage medium is performed for each layer of the multilayer storage medium.

It is a fifth object of the present invention to provide a computer-readable medium determining separate focusing for writing data to and reading data from the multilayer storage medium. According to this fifth aspect of the present invention, this object is achieved by a computer program product comprising a computer-readable medium having computer program code means, which, when loaded in the portable storage medium-initializing device or a computer, make said storage medium-initializing device or the computer execute the steps of writing test data sequences using different estimated first focus offset parameter values, reading the test data sequences using a second focus offset parameter value, determining values of at least one data deviation measure of the read test data sequences for at least some of the estimated first focus offset parameter values, and determining the first focus offset parameter value in dependence upon the determined values of at least one data deviation measure, such that the block error rate of the read-out of content data, written to the multilayer storage medium while using the determined first focus offset parameter value and read from the multilayer storage medium while using the determined second focus offset parameter value, is minimized.

The gist of the present invention is the provision of separate focusing parameter values for reading and writing of recordable multilayer storage media.

The present invention has the overall advantage that a block error rate of a read-out of written data is minimized by providing a first focus offset parameter value for writing content data to a portable storage medium. This is advantageous because data errors that cannot be recovered, which may be the result of high block error rates, are not tolerated by consumers.

The method defined in claim 3 is directed towards using different power levels during writing of test data sequences. This is advantageous because the determined parameter values may be further optimized.

The method defined in claim 5 is directed towards making the determined first focus offset parameter value available on the storage medium. This is advantageous because an optical consumer drive, in the case of the storage medium being an optical disc, can easily access the determined first focus offset parameter value.

The method defined in claim 6 and the unit defined in claim 8 are directed towards providing a second data deviation measure for determining the first focus offset parameter value. This is advantageous because the second data deviation measure can be taken into account for determining the first focus offset parameter value.

Claim 9 is directed towards an initializing device using the determined first focus offset parameter value. This is advantageous because the determined first focus offset parameter value can be provided on the portable storage medium.

Claim 10 is directed towards a method of writing content data by using the determined first focus offset parameter value. This is advantageous because the block error rate of the read-out of written content data is minimized.

These and other aspects of the invention are apparent from and will be elucidated with reference to the embodiments described hereinafter.

In the drawings,

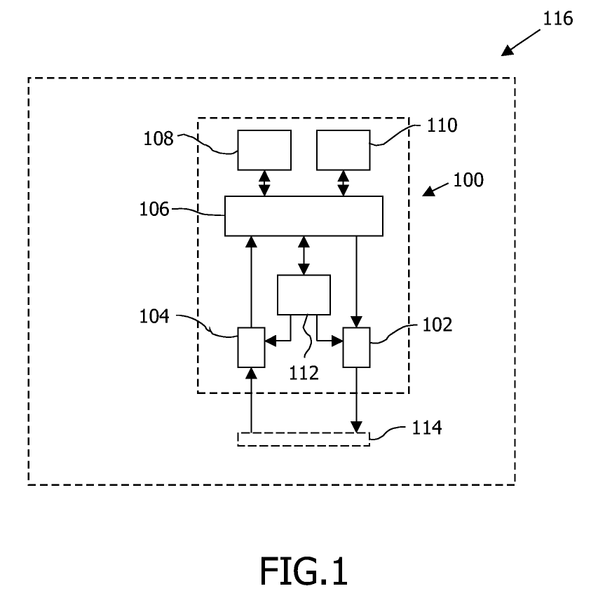

FIG. 1 is a schematic representation of a first focus offset parameter-determining unit according to an embodiment of the present invention,

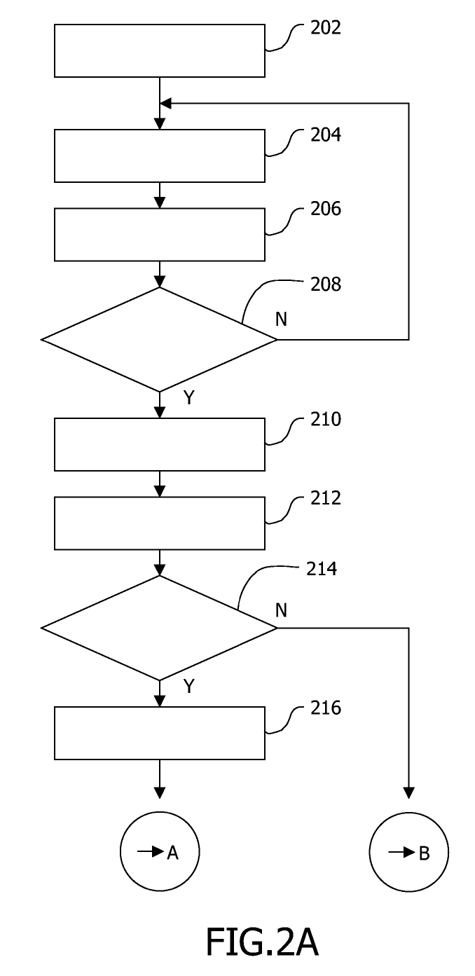

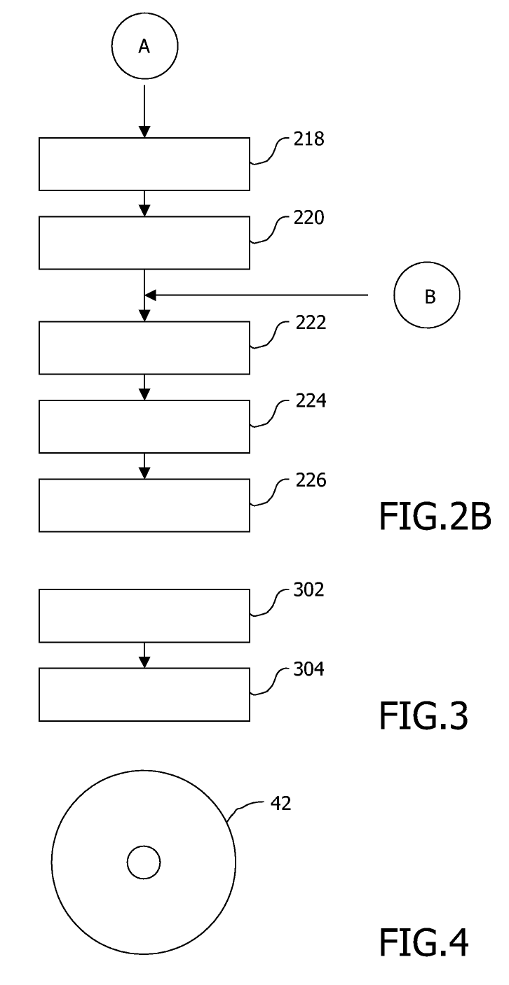

FIG. 2 is a flow chart of a method of determining a first focus offset parameter value according to an embodiment of the present invention,

FIG. 3 is a flow chart of a method of writing content data to a storage medium according to an embodiment of the present invention, and

FIG. 4 shows a computer program product according to an embodiment of the present invention.

Writing data to and reading the written data from a portable storage medium at a high data rate and with a low error rate often requires optimization of both write and read-related parameters.

It is well known that, by writing data to a standard single-layer optical disc and spinning this disc at a high speed during reading of said written data, a good read performance may be achieved by using standard read and write techniques. However, it has been observed that writing data to a double-layer optical disc and spinning this disc at a high speed during reading of the written data may cause unrecoverable errors of the read-out of the written data. This behavior is not observed when using standard single-layer optical discs.

Writing data to a standard single-layer optical disc having its data layer positioned at a depth of 0.6 mm from the planar surface and reading the written data may thus be performed at a certain spinning speed without the occurrence of any unrecoverable errors. In contrast, unrecoverable data errors occur in the read-out of written data when writing data to a double-layer optical disc having its two data layers, L0 and L1, positioned at a distance of 0.56 mm and 0.64 mm, respectively, from the planar surface of the optical disc.

Although writing data to a double-layer optical disc is a process similar to writing data to a single-layer optical disc, a new type of behavior is observed because unrecoverable errors only occur in the double-layer optical disc. In fact, the occurrence of unrecoverable errors in double-layer optical discs has been found to correlate with different focus parameters for the laser used during reading data from the optical disc, on the one hand, and during writing data to the optical disc, on the other hand. Indeed, it was found that the use of a focus offset parameter value optimized for reading data from an optical disc, in the process of writing data to the optical disc, as used for single-layer optical discs, causes unrecoverable data errors in the read-out of the written data for double-layer optical discs. For this reason, the focus offset parameter values specifically used for reading data from and writing data to the optical disc are individually optimized.

The unrecoverable data errors can be reduced to a minimum by optimizing the focus offset parameter value used for writing and the focus offset parameter value used for reading, and by writing data to a portable storage medium, for instance, an optical disc, using the focus offset parameter value optimized for writing, and by reading the written data using the focus offset parameter value optimized for reading the written data.

FIG. 1 is a schematic representation of a first focus offset parameter-determining unit according to an embodiment of the present invention. An example of the first focus offset parameter is the focus offset parameter value used for writing data to the optical disc as an example of a portable storage medium.

According to this embodiment of the present invention, the first focus offset parameter-determining unit 100 comprises a data-writing unit 102 arranged to write data to a portable storage medium 114, a data-reading unit 104 arranged to read data from the portable storage medium 114, a control unit 106 connected to the data-writing unit 102 and the data-reading unit 104 arranged to provide different estimated first focus offset parameter values to the data-writing unit 102, to provide a second focus offset parameter value to the data-reading unit 104, and to control the steps of determining the first focus offset parameter value.

According to this embodiment of the present invention, the first focus offset parameter-determining unit 100 further comprises a jitter-determining unit 108, which is an example of a first data deviation measure-determining unit, which jitter-determining unit is arranged to determine the jitter of data read from the data-reading unit 104, and a block error rate-determining unit 110, which is an example of a second data deviation measure-determining unit, which block error rate-determining unit 110 is arranged to determine the block error rate of data read from the data-reading unit 104. The jitter-determining unit 108 and the block error rate-determining unit 110 are connected to the control unit 106 which controls determining of the jitter and the block error rate.

The first focus offset parameter-determining unit 100 also comprises a focus offset parameter-forwarding unit 112 connected to the control unit 106, which focus offset parameter-forwarding unit 112 is arranged to assist in determining the first focus offset parameter value and to forward the first focus offset parameter value to the data-writing unit 102 under the control of the control unit 106. The focus offset parameter-forwarding unit 112 is further arranged to assist in determining the second focus offset parameter value and to forward the second focus offset parameter value to the data-reading unit 104 under the control of the control unit 106.

Moreover, FIG. 1 indicates a schematic portable storage medium-initializing device 116 comprising the first focus offset parameter-determining unit 100, according to the present invention, and a portable storage medium 114, to which data may be written and from which data may be read. The portable storage medium-initializing device 116 is arranged to initialize portable storage media 114 by storing, on the portable storage medium 114, a parameter from which the first focus offset parameter value can be obtained, as this parameter is related to the determined first focus offset parameter value. According to an alternative embodiment of the present invention, the first focus offset parameter value, as deterrmined by the first focus offset parameter value-determining unit 100, is stored on the portable storage medium 114.

This first focus offset parameter value, which is stored on the portable storage medium 114, will thus be available, for instance, when a consumer wishes to write data to an optical disc by using a consumer optical disc drive. The disc drive can thus read the optimized first focus offset parameter value, or the parameter that is related to said first focus offset parameter value, in order to use this read value for writing data to the optical disc so as to allow reading of the written data from the optical disc without the occurrence of unrecoverable data errors.

The present invention will now be explained in more detail with reference to FIGS. 2A and 2B presenting flow charts of a method of determining a first focus offset parameter value, and Table 1 presenting short task descriptions of the steps of said method, according to an embodiment of the present invention.

TABLE 1
Short task descriptions of the steps of the method of
determining a first focus offset parameter value,
according to an embodiment of the present invention.

| STEP | |
|---|---|
| NO. | SHORT TASK DESCRIPTIONS OF STEPS |
| 202 | Obtaining focus offset read value |
| 204 | Selecting a focus offset write value |
| 206 | Performing jitter OPC including writing test data sequences and |
| | measuring jitter and Bler of read-out of written data sequences |
| 208 | Jitter OPC performed at five focus offset write values |
| 210 | Determining the focus offset write value where jitter is minimum |
| 212 | Obtaining Bler at focus offset value |
| 214 | Is Bler > Bler_threshold? |
| 216 | Obtaining Bler at (focus offset value + Δ) |
| 218 | Determining minimal \|Δ\| for which Bler at |
| | (focus offset value + Δ) < Bler_threshold |
| 220 | Setting focus offset value = focus offset value + Δ) |
| 222 | Setting focus offset write = focus offset value |
| 224 | Calculating focus offset shift = focus offset write − focus offset |
| | read |
| 226 | Storing focus offset shift on optical disc |

According to an embodiment of the present invention, the first step of the method of determining a first focus offset parameter value is the step of obtaining a focus offset read value, step 202. The focus offset read value is an example of a second focus offset parameter value. According to this embodiment of the present invention, the focus offset read value is obtained by writing test data to the optical disc, again being an example of the portable storage medium, reading the written test data by using different focus offset read values, and determining the jitter, as a data deviation measure, as a function of the focus offset read values used for reading. The focus offset read value for which the jitter is minimal, is the optimized focus offset read value, to be used for optimized reading of data. This focus offset read value is thus the second focus offset parameter value that is used in the method according to the present invention. It can be noted that the focus offset parameter value used during writing the test data may be an estimate of the optimized focus offset parameter value.

According to an alternative embodiment of the present invention, the second focus offset parameter value optimized for reading may be obtained from elsewhere, for instance, by reading a value from the portable storage medium or by the value from a memory that may be connected to the first focus offset-determining unit 100. Such a memory unit may be comprised in the portable storage medium-initializing device 116.

The subsequent step of the method of determining a first focus offset parameter value is the step of selecting a focus offset write value, step 204, which value is an example of the first focus offset parameter value. According to an embodiment of the present invention, a focus offset write value is selected in this step, which selected value is used below for writing test data to the portable storage medium. Since the focus offset read value is a good first estimate of the focus offset write value, selection of focus offset write values around the focus offset read value furnishes an adequate estimation of first focus offset parameter values. This step of selecting a focus offset write value, step 204, is performed by the control unit 106 with the assistance of the focus offset parameter-forwarding unit 102, which control unit 106 has access to the focus offset read value, being an example of the second focus offset parameter value.

According to an embodiment of the present invention, the portable storage medium is an optical disc such as a DVD, a HD-DVD, a BD, an MD, a CD or any other optical disc. In an alternative embodiment, the portable storage medium is a magneto-optical disc and in another embodiment it is a magnetic storage medium, such as a magnetic card or a magnetic tape or the like.

The portable storage medium will hereinafter be referred to as optical disc, although it may very well be a different type of storage medium.

Having selected a focus offset write value, the step of performing jitter optimal power calibration (OPC) is executed, step 206. This step includes writing test data sequences to the optical disc, and determining the jitter and the block error rate (Bler) of the read-out of written data sequences, wherein jitter and Bler are data deviation measures. According to an embodiment of the present invention, OPC comprises the steps of writing test data sequences to the optical disc by using the selected focus offset write value as a function of different write power values. A number of different power values, for instance, five or more but at least three are chosen and test data sequences are written to the optical disc. For each write power value, the written data is read out and jitter and Bler values of the read data are determined.

Since the jitter is parabolically dependent on the write power used for writing the test data, a minimal jitter may be obtained when drawing a jitter graph as a function of the write power used. The write power that corresponds to the minimal jitter value is the optimal write power, because a minimal jitter of the read-out may be obtained by using this write power.

In the method of determining a first focus offset parameter value, step 206 is performed by collaboration of the units comprised in the first focus offset parameter-determining unit 100. Test data sequences are written to an optical disc 114 by the data-writing unit 102 using a focus offset write value forwarded by the focus offset parameter-forwarding unit 112 under the control of, and as determined by, the control unit 106. The test data sequences are read by using a focus offset read value forwarded by the focus offset parameter-forwarding unit 112 under the control of, and as determined by, the control unit 106. Jitter is determined by the jitter-determining unit 108, which is an example of the first data deviation measure-determining unit.

In this step, step 206, the block error rate is also determined by the block error rate-determining unit 110, which is an example of the second data deviation measure-determining unit.

The write power value for which jitter is minimal is obtained by the control unit with the assistance of the jitter-determining unit 108. The measured jitter and block error rate values acquired at the different write power levels are stored for further usage, for example, in the control unit 106. For the purpose of storing measurement data, the control unit 106 may have an internal memory unit (not shown in FIG. 1).

Subsequently, the step of determining whether jitter OPC is performed at five focus offset write values, as an example of an intermediate number of a plurality of focus offset write values, or is not performed, step 208. According to this embodiment of the present invention, it is thus determined whether jitter OPC has been performed by using five focus offset write parameters. According to alternative embodiments of the present invention, this number of write values for which jitter OPC is performed is 3, 4, 6 or 7. Also other values may be used.

Step 206 is performed by the control unit 106, which also has access to the measurement values, as described above. If the control unit 106 determines that jitter OPC has not been performed at five focus offset write values, but at a smaller number of focus offset write values, the step of selecting a focus offset write value, step 204, is chosen to be the next step. If so, a focus offset write value different from the earlier chosen value or values is chosen, for the step of writing subsequent test data sequence, step 206.

These steps of selecting a focus offset write value, step 204, and performing jitter OPC including writing of test data sequences and measuring jitter and Bler of read-out of written data sequences, step 206, are performed until the jitter OPC has been performed at five different focus offset write values.

If five jitter OPCs have been performed, the subsequent step of the method is the step of determining the focus offset write value at which jitter is minimal, step 210.

In the above steps, minimal jitter values were obtained at five different focus offset write values. In step 210, it is determined which focus offset write value of the existing values for which jitter was obtained corresponds to the lowest jitter value, that is, results in the lowest jitter value of the read-out of test data from the optical disc, which test data were written by using said focus offset write value. According to an embodiment of the present invention, this step is performed by the control unit 106 of the first focus offset parameter-determining unit 100.

Having obtained a focus offset write parameter for which jitter is minimal, a subsequent step of obtaining the block error rate at the determined focus offset value is performed, step 212. According to the embodiment of the present invention, it is the block error rate, being one data deviation measure, which is determined.

In an alternative embodiment of the present invention, it is the bit error rate of the read-out of test data written by using the determined focus offset write value, which is determined.

Since the block error rate or alternatively the bit error rate is a very important data deviation measure, it is beneficial to obtain pertinent determined values of this data deviation measure at the determined focus offset write value. This step may be performed by the control unit 106 with the assistance of the block error rate-determining unit 110.

Having obtained the block error rate, the next step is to determine whether the determined block error rate is higher or not higher than a block error rate threshold, step 214. If the determined block error rate is higher than the block error rate threshold, in step 214, as determined by the control unit with the assistance of the block error rate-determining unit 110, the block error rate is not acceptable. The read-out of the written test data thus contains too many read errors.

According to an embodiment of the present invention, a block error rate threshold value of 280 errors may be used, which value is measured for test data comprising 8 error correction code (ECC) blocks. In an alternative embodiment, other values may be used.

The present object at this stage is to find a modified alternative focus offset write value for which the block error rate is lower than the block error rate threshold. Since the block error rate is an essential data deviation measure, to be respected as being void of unrecoverable data errors in the read-out of the test data, alternative focus offset write values are obtained.

In the next step of obtaining a block error rate at focus offset value+Δ, step 216, the block error rate is obtained at a focus offset value that is updated by a small step, Δ, according to an embodiment of the present invention. This step typically corresponds to the difference between the determined focus offset write value and the closest neighboring focus offset write value, but it may also correspond to a larger value. Having determined the block error rate at a closely positioned focus offset write value, the step of determining the minimal |Δ|, i.e. the length of the focus offset step Δ for which the block error rate at focus offset value+Δ, <block error rate threshold, step 218, is performed. In this step, a minimal focus offset value is thus determined, which is required to obtain a block error rate that is lower than the block error rate threshold.

According to an embodiment of the present invention, this step is performed by stepping through the focus offset values for which the block error rate was determined and by selecting the smallest step required to obtain an acceptable block error rate which is lower than the block error rate threshold.

In an alternative embodiment of the present invention, this step comprises determining the block error rate at the two closest neighboring focus offset values, comparing the determined block error rate values with the block error rate threshold and selecting one of them if the corresponding block error rate is lower than the threshold value, or determining the relevant block error rate at an additional focus offset value further away from the focus offset value as determined in step 212.

Again, since the control unit has access to the measurement values, possibly from a memory within the control unit 106, this step of determining the minimal |Δ| for which the block error rate at focus offset value +Δ<block error rate threshold, step 218, is performed by the control unit 106 according to an embodiment of the present invention.

The focus offset step Δ may be either a positive or a negative value. This implies that the focus offset value, at which the block error rate is lower than the predetermined block error rate threshold, may be a focus offset parameter value that is either larger or smaller than the focus offset value at which the jitter value is minimal.

Having obtained the minimal focus offset step Δ, the step of setting the focus offset value equal to the focus offset value+Δ, step 220, is performed by the control unit 106, according to an embodiment of the present invention.

After step 220, and after step 214 if the block error rate was not higher than the block error rate threshold, as determined in step 214, the step of setting the focus offset write equal to focus offset value, step 222, is executed. The focus offset write value is thus set to be equal to the current value of the focus offset value, as determined in step 220, according to an embodiment of the present invention.

According to an alternative embodiment of the present invention, steps 220 and 222 are combined in one step if the block error rate is higher than the block error rate threshold as determined in step 214.

Having obtained a focus offset write value in step 222 and having access to the focus offset read value from step 202, a focus offset shift value is calculated by calculating the focus offset shift as the focus offset write value minus the focus offset read value, in step 224, according to an embodiment of the present invention.

Having access to the focus offset shift value from step 224, this value is stored on the optical disc in step 226, according to an embodiment of the present invention.

According to an alternative embodiment of the present invention, a parameter that is different from the focus offset shift value but related to the focus offset write value is stored on the optical disc. One such alternative example is the focus offset write value itself that may be stored on the optical disc.

It is to be understood that a relation between a first focus offset parameter value optimized for writing data to a portable storage medium and a second focus offset parameter value optimized for reading data from said portable storage medium may be used for writing and reading data in such a way that unrecoverable data errors during read-out of written data can be minimized.

The first focus offset parameter value or a parameter related to this value may thus be stored on an optical disc 114 to be available, for instance, when a consumer wishes to write data to the optical disc by using a consumer optical disc drive.

The following method will be explained with reference to the flow chart of FIG. 3 and Table 2, presenting a flow chart of a method of writing content data to a portable storage medium and short task descriptions of the steps of said method, according to an embodiment of the present invention.

TABLE 2
Short task descriptions of the steps of the method of writing
content data to a portable multilayer storage medium,
according to an embodiment of the present invention.

| STEP NO. | SHORT TASK DESCRIPTIONS OF STEPS |
|---|---|
| 302 | Obtaining a parameter at least related to the first focus offset |
| | parameter value |
| 304 | Writing content data to a portable multilayer storage medium |

According to an embodiment of the present invention, the method of writing content data to a portable storage medium starts from step 302, i.e. by obtaining a parameter which is at least related to the first focus offset parameter value as determined in accordance with the method of determining the first focus offset parameter value, as described above. As the parameter which is at least related to the first focus offset parameter value may be read from the portable storage medium, it can be easily accessed by, for instance, an optical disc drive in the case of a consumer wishing to write content data to the optical disc. The disc drive can thus read the parameter or, according to an alternative embodiment, read the first focus offset parameter value directly from the optical disc. In an embodiment of the present invention, the parameter related to the first focus offset parameter value is a focus offset shift value in the form of the difference between the focus offset write value, i.e. the first focus offset parameter value, and the focus offset read value, i.e. the second focus offset parameter value.

An optical disc drive reading such a focus offset shift value may thus easily obtain the focus offset write value by determining the focus offset read value, which is well-known to a person skilled in the art, and by adding this determined focus offset read value to the focus offset shift value read from the optical disc.

Determining the focus offset read value is a quick process and is easily performed in a consumer optical drive, whereas determining the focus offset write value is more time-consuming and may be performed by the manufacturer of the optical discs.

The subsequent step of the method of writing content to a portable multilayer storage medium is the step of writing content data to a layer of the multilayer portable storage medium by using the obtained first focus offset parameter value, step 304. Optimized storing is achieved by storing content data on an optical disc using this optimized focus offset write value. The occurrence of unrecoverable data errors is minimized by reading content data using a determined optimized focus offset read value, wherein the data were written by using the determined focus offset write value.

Methods of determining a first focus offset parameter value and writing content data to a portable multilayer storage medium using the determined first focus offset parameter value have thus been explained.

According to a preferred embodiment of the present invention, the method of determining the first focus offset parameter value for writing content data to a portable multilayer storage medium is performed for each layer because each layer of the multilayer storage medium has different read and write properties. In the case of a double-layer optical disc, one determination is performed for the first layer L0 and another determination is performed for the second layer L1. The determined focus offset write values or parameters at least related to each value are subsequently stored in each layer on the optical disc.

FIG. 4 shows a computer program product 42 according to an embodiment of the present invention. This computer program product is intended to make a computer execute the program when said computer program product is loaded in the computer. The computer program product may be provided as a CD-ROM according to an embodiment of the present invention. However, the computer program product may alternatively be provided on a different type of disc such as a DVD, a hard disk, an MD disc, or provided in a memory or another storage capacity.

The control unit of the first focus offset parameter value-determining unit is normally realized as a processor with a connected computer program memory.

It is to be noted that the invention can be varied in many more ways, of which the alternative embodiments are only a few, non-limiting examples. The scope of the present invention is only limited by the appending claims.

According to an alternative embodiment of the present invention, the units comprised in the first focus offset parameter-determining unit 100 may be connected to each other in a different way. Some of these units may be comprised in other units, such as the focus offset parameter-forwarding unit 112 in the control unit 106. The control unit 106 may also be divided into more units, all within the scope of the invention.

According to another embodiment of the present invention, the steps of the method as presented in FIGS. 2A and 2B may be performed in a different order. Moreover, in alternative embodiments of the present invention, some steps may be combined and some may be divided into a plurality of steps.

1. A method of determining a first focus offset parameter value for writing content data to a multilayer storage medium (114) based on a determined second focus offset parameter value for reading, the method comprising the steps of:
writing test data sequences using different estimated first focus offset parameter values (step 206),
reading the test data sequences using the determined second focus offset parameter value (step 206),
determining values of at least one data deviation measure of the read test data sequences for at least some of the estimated first focus offset parameter values (step 206), and
determining the first focus offset parameter value in dependence upon the determined values of at least one data deviation measure (steps 210,222), such that the block error rate of the read-out of content data, written to the multilayer storage medium (114) while using the determined first focus offset parameter value and read from the multilayer storage medium (114) while using the determined second focus offset parameter value, is minimized.

2. The method according to claim 1, in which the step of determining the first focus offset parameter value (steps 210,222) comprises determining the first focus offset parameter value for a minimum of the at least one data deviation measure (step 210).

3. The method according to claim 1, in which the step of writing test data sequences further comprises writing test data sequences using different writing power levels (step 206).

4. The method according to claim 3, in which the step of determining values of at least one data deviation measure comprises determining the values in dependence upon the different power levels (step 210).

5. The method according to claim 1, further comprising the step of storing a parameter at least related to the determined first focus offset parameter value on the storage medium (step 226).

6. The method according to claim 1, further comprising the step of:
determining values of a second data deviation measure of the read test data sequences for at least some of the estimated first focus offset parameter values (step 206), wherein the step of determining the first focus offset parameter value further comprises determining the first focus offset parameter value in dependence upon the determined values of the second data deviation measure (steps 216, 218, 220).

7. A first focus offset parameter value-determining unit (100) for determining a first focus offset parameter value for writing data to a multilayer storage medium (114) based on a determined second focus offset parameter value, said first focus offset parameter value-determining unit (100) comprising:
a data-writing unit (102) arranged to write test data sequences to the storage medium using different estimated first focus offset parameter values,
a data-reading unit (104) arranged to read test data sequences from the storage medium (114) using a second focus offset parameter value,
a first data deviation measure-determining unit (108) arranged to determine values of a first data deviation measure of the read test data sequences for at least some of the estimated first focus offset parameter values,
a control unit (106) connected to the data-writing unit (102), the further data-writing unit (104) and the first data deviation measure-determining unit (108), said control unit (106) being arranged to control writing the test data sequences using different estimated first focus offset parameter values (step 206), reading the test data sequences using a second focus offset parameter value (step 206), determining values of at least one data deviation measure of the read test data sequences for at least some of the estimated first focus offset parameter values (step 206), and determining the first focus offset parameter value in dependence upon the determined values of at least one data deviation measure (steps 210,222),
such that the block error rate of the read-out of data, written to the multilayer storage medium (114) while using the determined first focus offset parameter value and read from the multilayer storage medium (114) while using the determined second focus offset parameter value, is minimized.

8. A first focus offset parameter value-determining unit (100) according to claim 7, further comprising:
a second data deviation measure-determining unit (110) arranged to determine values of a second data deviation measure of the read test data sequences for at least some of the estimated first focus offset parameters, wherein the control unit (106) is further arranged to determine the first focus offset parameter value in dependence upon the determined values of the second data deviation measure.

9. A storage medium-initializing device (116) for initializing a multilayer storage medium (114), wherein said storage medium-initializing device (116) is arranged to receive the multilayer storage medium (114), the device comprising:
a first focus offset parameter value-determining unit (100) according to claim 7, arranged to determine a first focus offset parameter value, such that the storage medium-initializing device (116) can initialize the multilayer storage medium (114) by storing at least a parameter value that is related to the first focus offset parameter value on said storage medium (114).

10. A method of writing content data to a multilayer storage medium (114), the method comprising the steps of:
obtaining a parameter at least related to the first focus offset parameter value as determined by means of the method according to claim 1, in dependence upon the multilayer storage medium (114, step 302), and
writing content data to a layer of the multilayer storage medium (114) by using the obtained first focus offset parameter value (step 304), such that the block error rate of a read-out of the written data is minimized.

11. A computer program product (42) comprising a computer-readable medium having computer program code means, which, when loaded in the portable storage medium-initializing device or a computer, make said storage medium-initializing device or the computer execute the steps of:
writing test data sequences using different estimated first focus offset parameter values (step 206),
reading the test data sequences using a second focus offset parameter value (step 206),
determining values of at least one data deviation measure of the read test data sequences for at least some of the estimated first focus offset parameter values (step 206), and
determining the first focus offset parameter value in dependence upon the determined values of at least one data deviation measure (steps 210,222), such that the block error rate of the read out-of content data, written to the multilayer portable storage medium (114) while using the determined first focus offset parameter value and read from the multilayer portable storage medium (114) while using the determined second focus offset parameter value, is minimized.
